(19) United States
(12) Patent Application Publication
(10) Pub. No.: US 2015/0138333 A1
(43) Pub. Date: May 21, 2015

(54) Agent Interfaces for Interactive Electronics that Support Social Cues

(71) Applicants: Richard Wayne DeVaul, Mountain View, CA (US); Daniel Aminzade, Mountain View, CA (US)

(72) Inventors: Richard Wayne DeVaul, Mountain View, CA (US); Daniel Aminzade, Mountain View, CA (US)

(73) Assignee: Google Inc., Mountain View, CA (US)

(21) Appl. No.: 13/407,159

(22) Filed: Feb. 28, 2012

(51) Int. Cl. A63H 33/00; G06F 3/01; G06F 3/16; H04N 5/225; G06K 9/00; H04R 1/32

(52) U.S. Cl. CPC G06F 3/013; H04R 1/32; H04N 5/2257; G06F 3/16; G06K 9/00288
USPC 348/78; 446/175

(57) ABSTRACT

An anthropomorphic device, perhaps in the form factor of a doll or toy, may be configured to control one or more media devices. Upon reception or a detection of a social cue, such as movement and/or a spoken word or phrase, the anthropomorphic device may aim its gaze at the source of the social cue. In response to receiving a voice command, the anthropomorphic device may interpret the voice command and map it to a media device command. Then, the anthropomorphic device may transmit the media device command to a media device, instructing the media device to change state.

### BACKGROUND

With the rise of Internet Protocol (IP) based networking, the use of media technologies continue to expand and diversify. Modern televisions, digital video recorders (DVRs), Digital Video Disc (DVD) players, stereo components, home automation components, MP3 players, cell phones, and other devices can now communicate with one another via IP. This advent, in turn, has brought about dramatic changes in how these media devices are used.

### SUMMARY

In an example embodiment, an anthropomorphic device may detect a social cue. The anthropomorphic device may include a camera and a microphone, and detecting the social cue may comprise the camera detecting a gaze directed toward the anthropomorphic device. The anthropomorphic device may aim the camera and the microphone based on the direction of the gaze. While the gaze is directed toward the anthropomorphic device, the anthropomorphic device may receive an audio signal via the microphone. Based on receiving the audio signal while the gaze is directed toward the anthropomorphic device, the anthropomorphic device may (i) transmit a media device command to a media device, and (ii) provide an acknowledgement of the audio signal. The media device command may be based on the audio signal.

A further example embodiment may involve an article of manufacture including a non-transitory computer-readable medium. The computer-readable medium may have stored thereon program instructions that, upon execution by an anthropomorphic computing device, cause the anthropomorphic computing device to perform operations. These operations may include detecting a social cue at the anthropomorphic computing device, wherein the anthropomorphic computing device includes a camera and a microphone, and wherein detecting the social cue comprises the camera detecting a gaze directed toward the anthropomorphic computing device. The operations may also include aiming the camera and the microphone based on the direction of the gaze, and, while the gaze is directed toward the anthropomorphic computing device, receiving an audio signal via the microphone. Additionally, the operations may include, based on receiving the audio signal while the gaze is directed toward the anthropomorphic computing device, (i) transmitting a media device command to a media device, and (ii) providing an acknowledgement of the audio signal, wherein the media device command is based on the audio signal.

Another example embodiment may involve an anthropomorphic device comprising, a camera, a microphone, and a processor. The anthropomorphic device may also include data storage containing program instructions that, upon execution by the processor, cause the anthropomorphic device to (i) detect a social cue, wherein detecting the social cue comprises the camera detecting a gaze directed toward the anthropomorphic device, (ii) direct the camera and the microphone based on the direction of the gaze, (iii) while the gaze is directed toward the anthropomorphic device, receive an audio signal via the microphone, and (iv) based on receiving the audio signal while the gaze is directed toward the anthropomorphic device, (a) transmit a media device command to a media device, and (b) provide an acknowledgement of the audio signal, wherein the media device command is based on the audio signal.

In still another example embodiment, an anthropomorphic device may detect a first audio signal. The anthropomorphic device may include a camera and a microphone array, and detecting the first audio signal may comprise the microphone array detecting the first audio signal. The anthropomorphic device may determine that the first audio signal encodes at least one pre-determined activation keyword. In response to determining that the first audio signal encodes the at least one pre-determined activation keyword, the anthropomorphic device may (i) process the first audio signal to determine a source direction of the first audio signal, and (ii) aim the camera at the source direction of the first audio signal. While the camera is aimed at the source direction of the first audio signal, the anthropomorphic device may receive a second audio signal via the microphone array. Based on at least one of input from the camera and the second audio signal, the anthropomorphic device may determine that the first audio signal and the second audio signal are from a common source. In response to determining that the first audio signal and the second audio signal are from the common source, the anthropomorphic device may (i) transmit a media device command to a media device, and (ii) provide an acknowledgement of the second audio signal. The media device command may be based on the second audio signal.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE FIGURES

FIG. 1 depicts a distributed computing architecture, including anthropomorphic devices, in accordance with an example embodiment.

FIG. 2A is a block diagram of a server device, in accordance with an example embodiment.

FIG. 2B depicts a cloud-based server system, in accordance with an example embodiment.

FIG. 3A depicts a block diagram of anthropomorphic device hardware and software, in accordance with an example embodiment.

FIG. 3B depicts example form factors of anthropomorphic devices, in accordance with example embodiments.

FIG. 4 is a message flow diagram, in accordance with an example embodiment.

FIG. 5 is another message flow diagram, in accordance with an example embodiment.

FIG. 6 is a flow chart, in accordance with an example embodiment.

FIG. 7 is another flow chart, in accordance with an example embodiment.

### DETAILED DESCRIPTION

### 1. Overview

In the past, the vast majority of media consumed by users was based either on broadcasts that users had no direct control over, or physical media that the users purchased or borrowed. Today, many users are eschewing broadcast and physical media in favor of on- demand media streaming, or digital-only downloaded media. For example, movies can now be streamed on demand, over IP, to a television, DVR, DVD player, cell phone, or computer. Additionally, users may purchase and download media, and store it digitally on their computers. This media may either be accessed on that computer or via another device.

Consequently, in some homes, these various media devices may be integrated, either via wireless or wireline networks, into one or more home entertainment systems. However, with the greater flexibility and power of these new media technologies comes the possibility that some users might find using such systems to be too daunting or complex. For example, if a user wants to watch a movie, he or she may have to decide which device displays the movie (e.g., a television or computer), which device streams the movie (e.g., a television, DVR, or DVD player), and whether the movie is streamed from a local or remote source (e.g., from a home media server or an online streaming service). If the media is streamed from a remote source, the user may need to also decide which of several content providers to use.

Further, in recent years, the use of home automation systems has also proliferated. These systems allow the centralized control of lighting, HVAC (heating ventilation and air conditioning), appliances, and/or windows curtains and shades of residential, business or commercial properties. Thus, from one location, a user can turn on or off the property's lights, change the property's thermostat settings, and so on. Further, the components of a home automation system may communicate with one another via, for example, IP and/or various wireless technologies. Some home automation systems support remote access so that the user can program and/or adjust the system's parameters from a remote control or from a computing device.

Thus, it may be desirable to be able to simplify the management and control of a variety of media devices that may comprise a home entertainment system or a home automation system. However, the embodiments disclosed herein are also applicable to other types of media devices used in other environments. For example, office communication and productivity tools, including but not limited to audio and video conferencing systems, as well as document sharing systems, may benefit from these embodiments. Also, the term “media device” is used herein for sake of convenience. It should be interpreted generically, to refer to any type of device that can be controlled. Thus, a media device may be a home entertainment device that plays media, a home automation device that controls the environmental aspects of a location, or some other type of device.

A function typically intended to simplify management and control of media devices is remote control. Particularly, the diversity of media devices has led to the popularity of so-called “universal” remote controls that can be programmed to control virtually any media device. Typically, these remote controls use line-of-sight infrared signaling. More recently, media devices that are capable of being controlled via other wireless technologies, such as Wifi or BLUETOOTH, have become available.

Regardless of the wireless technology supported, remote controls, especially universal remote controls, generally have a large number of buttons, and it is not always clear which remote control button affects a given media device function. Thus, modern remote controls often add to, rather than reduce, the complexity of home entertainment and home automation systems.

One possible way of mitigating this complexity is to have a remote control that responds to voice commands and/or social cues. However, there are challenges with getting such a mechanism to operate in a robust fashion. Particularly, the remote control may not be able to determine whether an audio signal that it receives is a voice command or background noise. For instance, in a noisy room, the remote control might not be able to properly recognize voice commands. Further, some individuals may find it intuitive to communicate with a remote control in a way that simulates human interaction.

Some aspects of the embodiments disclosed herein address controlling multiple media devices in a robust and easy-to-use fashion. For example, an anthropomorphic device may serve as an intelligent remote control. The anthropomorphic device may be a computing device with a form factor that includes human-like characteristics. For example, the anthropomorphic device may be a doll or toy that resembles a human, an animal, a mythical creature or an inanimate object. The anthropomorphic device may have a head (or a body part resembling a head) with objects representing eyes, ears, and a mouth. The head may also contain a camera, a microphone, and/or a speaker that correspond to the eyes, ears, and mouth, respectively.

Additionally, the anthropomorphic device may respond to social cues. For instance, upon detecting the presence of a user, the anthropomorphic device may adjust the position of its head and/or eyes to simulate looking at at the user. By making “eye contact” with the user, the user is presented with a familiar form of social interaction in which two parties look at each other while communicating.

If the user speaks a command while gazing back at the anthropomorphic device, the anthropomorphic device may access a profile of the user to determine, based on the user's preference encoded in the profile, how to interpret the command. The anthropomorphic device may also access a remote, cloud-based server to access the profile and/or to assist in determining how to interpret the command. Then, the anthropomorphic device may control, perhaps through Wifi, BLUETOOTH, infrared, or some other wireless or wireline technology, one or more media devices. In response to accepting the command, the anthropomorphic device may make an audio (e.g., spoken phrase or particular sound) or non-audio (e.g., a gesture and/or another visual signal) acknowledgement to the user.

In other embodiments, the anthropomorphic device may respond to verbal social cues. For example, the anthropomorphic device might have a “name,” and the user might address the anthropomorphic device by its name. In response to “hearing” its name, the anthropomorphic device may then engage in eye contact with the user in order to receive further input from the user.

### 2. Communication System and Device Architecture

The methods, devices, and systems described herein can be implemented using so-called “thin clients” and “cloud-based” server devices, as well as other types of client and server devices. Under various aspects of this paradigm, client devices (e.g., anthropomorphic devices), may offload some processing and storage responsibilities to remote server devices. At least some of the time, these client services are able to communicate, via a network such as the Internet, with the server devices. As a result, applications that operate on the client devices may also have a persistent, server-based component. Nonetheless, it should be noted that at least some of the methods, processes, and techniques disclosed herein may be able to operate entirely on a client device or a server device.

In the embodiments herein, anthropomorphic devices may include client device functions. Thus, the anthropomorphic devices may include one or more communication interfaces, with which the anthropomorphic devices communicate with one or more server devices to carry out anthropomorphic device functions. For sake of convenience, throughout this section anthropomorphic devices may be referred to generically as “client devices,” and may have similar hardware and software components as other types of client devices.

This section describes general system and device architectures for both client devices and server devices. However, the methods, devices, and systems presented in the subsequent sections may operate under different paradigms as well. Thus, the embodiments of this section are merely examples of how these methods, devices, and systems can be enabled.

A. Communication System

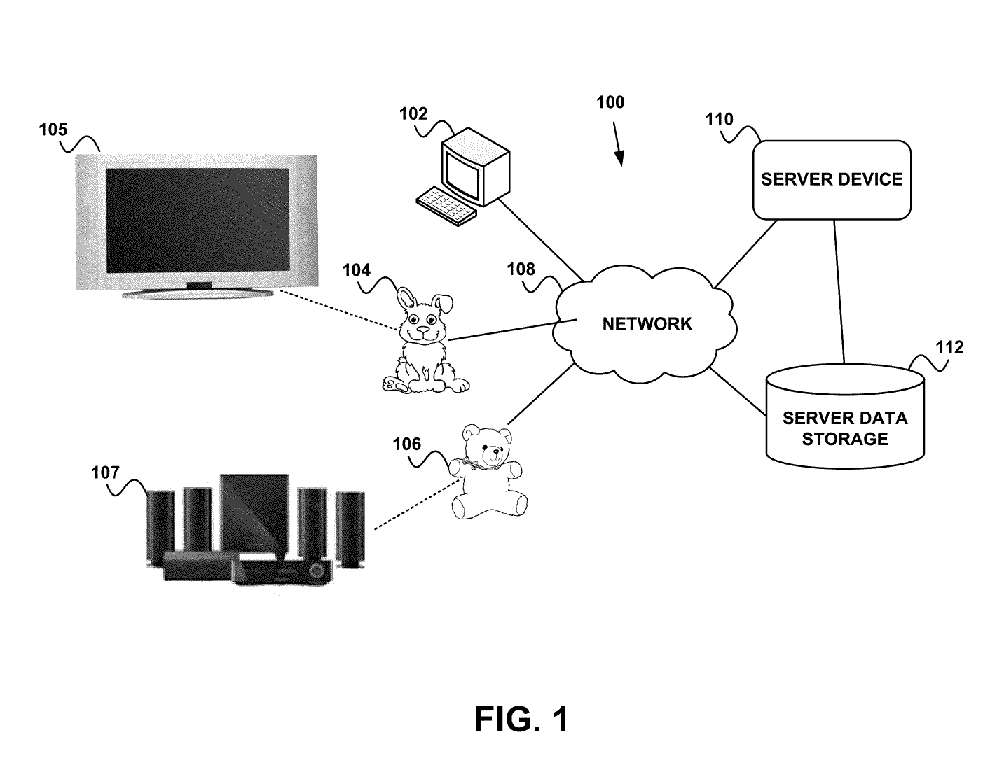

FIG. 1 is a simplified block diagram of a communication system 100, in which various embodiments described herein can be employed. Communication system 100 includes client devices 102, 104, and 106, which represent a desktop personal computer (PC), an anthropomorphic device in the shape of a rabbit, and an anthropomorphic device in the shape of a teddy bear, respectively. Each of these client devices may be able to communicate with other devices via a network 108 through the use of wireline or wireless connections.

Client device 102 may be a general purpose computer that can be used to carry out computing tasks and may communicate with other devices in FIG. 1. Anthropomorphic device 104 may be based on general purpose computing technology, and may be able to communicate with and/or control television 105. Anthropomorphic device 106 may also be based on general purpose computing technology, and may be able to communicate with and/or control stereo system 107.

Devices that display and/or play media, such as television 105, and stereo system 107, may be referred to as media devices. Other types of media devices include DVRs, DVD players, Internet appliances, and general purpose and special purpose computers. However, as noted above, “media device” is a generic term also encompassing home automation components and other types of devices.

In some possible embodiments, client devices 102, 104, and 106 and media devices 105 and 107 may be physically located in a single residential or business location. For example client devices 102 and 104, as well as media device 105, may be located in one room of a residence, while client device 106 and media device 107 may be located in another room of the residence. Alternatively or additionally, client devices 102, 104, and 106 may each be able to individually control both media devices 105 and 107.

Network 108 may be, for example, the Internet, or some other form of public or private Internet Protocol (IP) network. Thus, client devices 102, 104, and 106 may communicate with other devices using packet-switching technologies. Nonetheless, network 108 may also incorporate at least some circuit-switching technologies, and client devices 102, 104, and 106 may communicate via circuit switching alternatively or in addition to packet switching.

A server device 110 may also communicate via network 108. Particularly, server device 110 may communicate with client devices 102, 104, and 106 according to one or more network protocols and/or application-level protocols to facilitate the use of network-based or cloud-based computing on these client devices. Server device 110 may include integrated data storage (e.g., memory, disk drives, etc.) and may also be able to access a separate server data storage 112. Communication between server device 110 and server data storage 112 may be direct, via network 108, or both direct and via network 108 as illustrated in FIG. 1. Server data storage 112 may store application data that is used to facilitate the operations of applications performed by client devices 102, 104, and 106 and server device 110.

Although only three client devices, one server device, and one server data storage are shown in FIG. 1, communication system 100 may include any number of each of these components. For instance, communication system 100 may comprise dozens of client devices, thousands of server devices and/or thousands of server data storages. Furthermore, client devices may take on forms other than those in FIG. 1.

B. Server Device

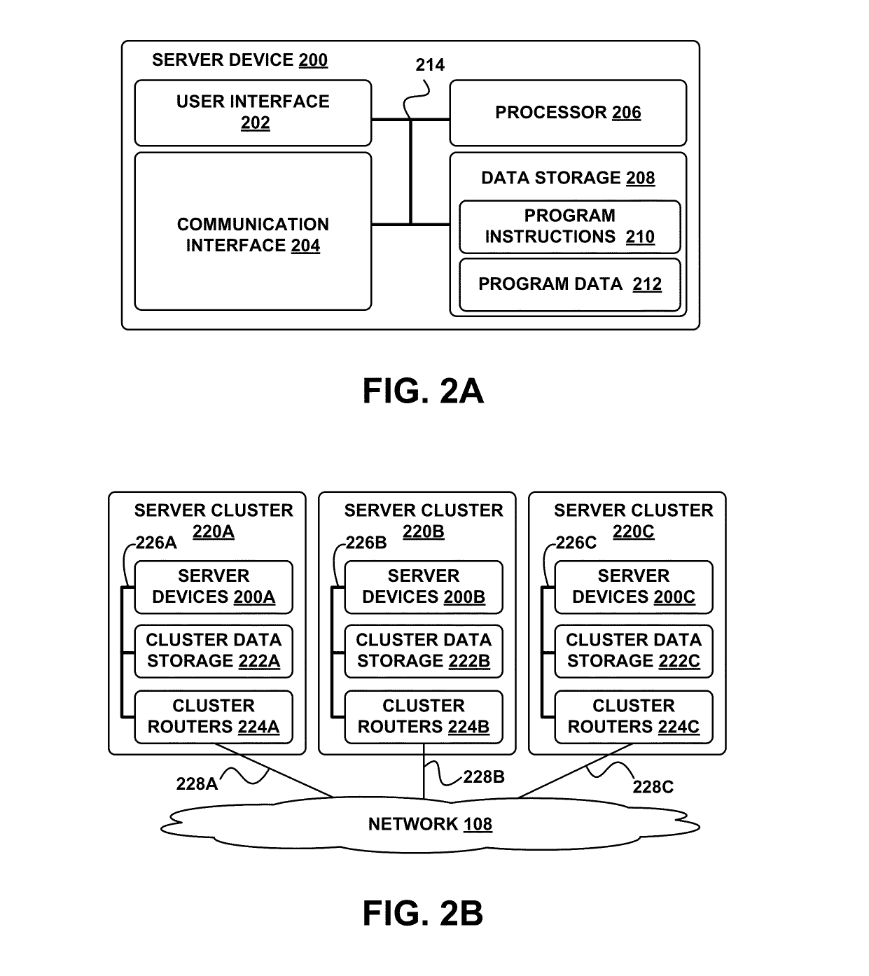

FIG. 2A is a block diagram of a server device in accordance with an example embodiment. In particular, server device 200 shown in FIG. 2A can be configured to perform one or more functions of server device 110 and/or server data storage 112. Server device 200 may include a user interface 202, a communication interface 204, processor 206, and data storage 208, all of which may be linked together via a system bus, network, or other connection mechanism 214.

User interface 202 may comprise user input devices such as a keyboard, a keypad, a touch screen, a computer mouse, a track ball, a joystick, and/or other similar devices, now known or later developed. User interface 202 may also comprise user display devices, such as one or more cathode ray tubes (CRT), liquid crystal displays (LCD), light emitting diodes (LEDs), displays using digital light processing (DLP) technology, printers, light bulbs, and/or other similar devices, now known or later developed. Additionally, user interface 202 may be configured to generate audible output(s), via a speaker, speaker jack, audio output port, audio output device, earphones, and/or other similar devices, now known or later developed. In some embodiments, user interface 202 may include software, circuitry, or another form of logic that can transmit data to and/or receive data from external user input/output devices.

Communication interface 204 may include one or more wireless interfaces and/or wireline interfaces that are configurable to communicate via a network, such as network 108 shown in FIG. 1. The wireless interfaces, if present, may include one or more wireless transceivers, such as a BLUETOOTH® transceiver, a Wifi transceiver perhaps operating in accordance with an IEEE 802.11 standard (e.g., 802.11b, 802.11g, 802.11n), a WiMAX transceiver perhaps operating in accordance with an IEEE 802.16 standard, a Long-Term Evolution (LTE) transceiver perhaps operating in accordance with a 3rd Generation Partnership Project (3GPP) standard, and/or other types of wireless transceivers configurable to communicate via local-area or wide-area wireless networks. The wireline interfaces, if present, may include one or more wireline transceivers, such as an Ethernet transceiver, a Universal Serial Bus (USB) transceiver, or similar transceiver configurable to communicate via a twisted pair wire, a coaxial cable, a fiber-optic link or other physical connection to a wireline device or network.

In some embodiments, communication interface 204 may be configured to provide reliable, secured, and/or authenticated communications. For each communication described herein, information for ensuring reliable communications (e.g., guaranteed message delivery) can be provided, perhaps as part of a message header and/or footer (e.g., packet/message sequencing information, encapsulation header(s) and/or footer(s), size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, the data encryption standard (DES), the advanced encryption standard (AES), the Rivest, Shamir, and Adleman (RSA) algorithm, the Diffie-Hellman algorithm, and/or the Digital Signature Algorithm (DSA). Other cryptographic protocols and/or algorithms may be used instead of or in addition to those listed herein to secure (and then decrypt/decode) communications.

Processor 206 may include one or more general purpose processors (e.g., microprocessors) and/or one or more special purpose processors (e.g., digital signal processors (DSPs), graphical processing units (GPUs), floating point processing units (FPUs), network processors, or application specific integrated circuits (ASICs)). Processor 206 may be configured to execute computer-readable program instructions 210 that are contained in data storage 208, and/or other instructions, to carry out various functions described herein.

Data storage 208 may include one or more non-transitory computer-readable storage media that can be read or accessed by processor 206. The one or more computer-readable storage media may include volatile and/or non-volatile storage components, such as optical, magnetic, organic or other memory or disc storage, which can be integrated in whole or in part with processor 206. In some embodiments, data storage 208 may be implemented using a single physical device (e.g., one optical, magnetic, organic or other memory or disc storage unit), while in other embodiments, data storage 208 may be implemented using two or more physical devices.

Data storage 208 may also include program data 212 that can be used by processor 206 to carry out functions described herein. In some embodiments, data storage 208 may include, or have access to, additional data storage components or devices (e.g., cluster data storages described below).

C. Server Clusters

Server device 110 and server data storage device 112 may store applications and application data at one or more places accessible via network 108. These places may be data centers containing numerous servers and storage devices. The exact physical location, connectivity, and configuration of server device 110 and server data storage device 112 may be unknown and/or unimportant to client devices. Accordingly, server device 110 and server data storage device 112 may be referred to as “cloud-based” devices that are housed at various remote locations. One possible advantage of such “could-based” computing is to offload processing and data storage from client devices, thereby simplifying the design and requirements of these client devices.

In some embodiments, server device 110 and server data storage device 112 may be a single computing device residing in a single data center. In other embodiments, server device 110 and server data storage device 112 may include multiple computing devices in a data center, or even multiple computing devices in multiple data centers, where the data centers are located in diverse geographic locations. For example, FIG. 1 depicts each of server device 110 and server data storage device 112 potentially residing in a different physical location.

FIG. 2B depicts a cloud-based server cluster in accordance with an example embodiment. In FIG. 2B, functions of server device 110 and server data storage device 112 may be distributed among three server clusters 220a, 220b, and 220c. Server cluster 220a may include one or more server devices 200a, cluster data storage 222a, and cluster routers 224a connected by a local cluster network 226a. Similarly, server cluster 220b may include one or more server devices 200b, cluster data storage 222b, and cluster routers 224b connected by a local cluster network 226b. Likewise, server cluster 220c may include one or more server devices 200c, cluster data storage 222c, and cluster routers 224c connected by a local cluster network 226c. Server clusters 220a, 220b, and 220c may communicate with network 108 via communication links 228a, 228b, and 228c, respectively.

In some embodiments, each of the server clusters 220a, 220b, and 220c may have an equal number of server devices, an equal number of cluster data storages, and an equal number of cluster routers. In other embodiments, however, some or all of the server clusters 220a, 220b, and 220c may have different numbers of server devices, different numbers of cluster data storages, and/or different numbers of cluster routers. The number of server devices, cluster data storages, and cluster routers in each server cluster may depend on the computing task(s) and/or applications assigned to each server cluster.

In the server cluster 220a, for example, server devices 200a can be configured to perform various computing tasks of server device 110. In one embodiment, these computing tasks can be distributed among one or more of server devices 200a. Server devices 200b and 200c in server clusters 220b and 220c may be configured the same or similarly to server devices 200a in server cluster 220a. On the other hand, in some embodiments, server devices 200a, 200b, and 200c each may be configured to perform different functions. For example, server devices 200a may be configured to perform one or more functions of server device 110, and server devices 200b and server device 200c may be configured to perform functions of one or more other server devices. Similarly, the functions of server data storage device 112 can be dedicated to a single server cluster, or spread across multiple server clusters.

Cluster data storages 222a, 222b, and 222c of the server clusters 220a, 220b, and 220c, respectively, may be data storage arrays that include disk array controllers configured to manage read and write access to groups of hard disk drives. The disk array controllers, alone or in conjunction with their respective server devices, may also be configured to manage backup or redundant copies of the data stored in cluster data storages to protect against disk drive failures or other types of failures that prevent one or more server devices from accessing one or more cluster data storages.

Similar to the manner in which the functions of server device 110 and server data storage device 112 can be distributed across server clusters 220a, 220b, and 220c, various active portions and/or backup/redundant portions of these components can be distributed across cluster data storages 222a, 222b, and 222c. For example, some cluster data storages 222a, 222b, and 222c may be configured to store backup versions of data stored in other cluster data storages 222a, 222b, and 222c.

Cluster routers 224a, 224b, and 224c in server clusters 220a, 220b, and 220c, respectively, may include networking equipment configured to provide internal and external communications for the server clusters. For example, cluster routers 224a in server cluster 220a may include one or more packet-switching and/or routing devices configured to provide (i) network communications between server devices 200a and cluster data storage 222a via cluster network 226a, and/or (ii) network communications between the server cluster 220a and other devices via communication link 228a to network 108. Cluster routers 224b and 224c may include network equipment similar to cluster routers 224a, and cluster routers 224b and 224c may perform networking functions for server clusters 220b and 220c that cluster routers 224a perform for server cluster 220a.

Additionally, the configuration of cluster routers 224a, 224b, and 224c can be based at least in part on the data communication requirements of the server devices and cluster storage arrays, the data communications capabilities of the network equipment in the cluster routers 224a, 224b, and 224c, the latency and throughput of the local cluster networks 226a, 226b, 226c, the latency, throughput, and cost of the wide area network connections 228a, 228b, and 228c, and/or other factors that may contribute to the cost, speed, fault-tolerance, resiliency, efficiency and/or other design goals of the system architecture.

D. Client Device Hardware and Software

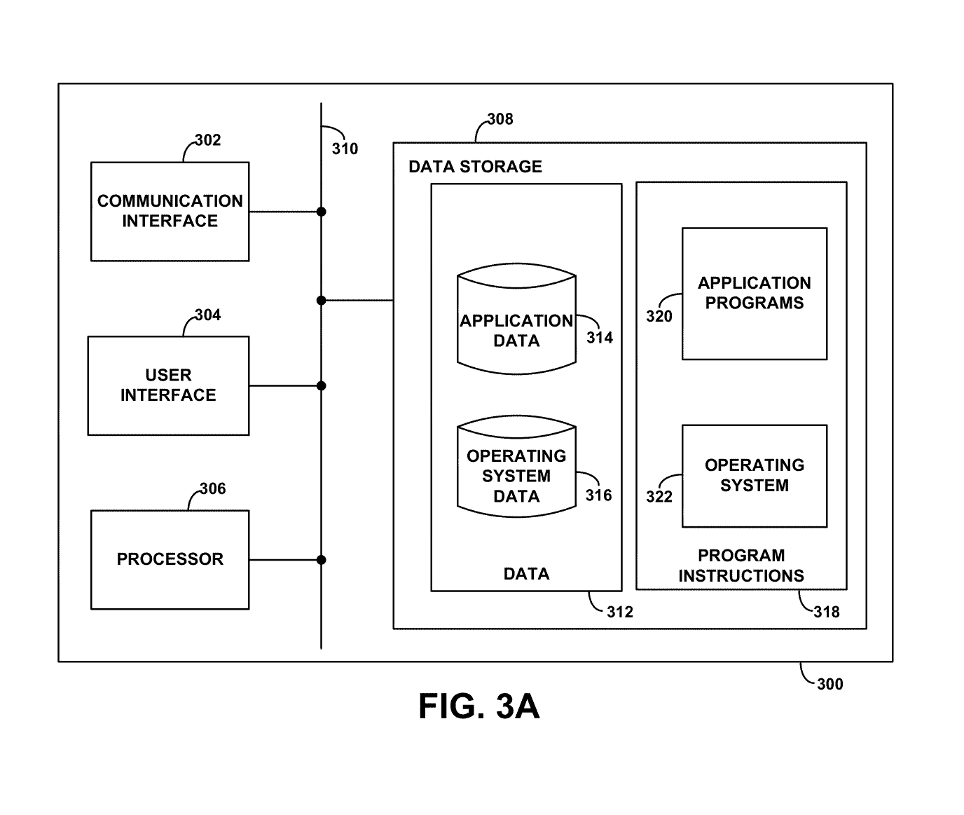

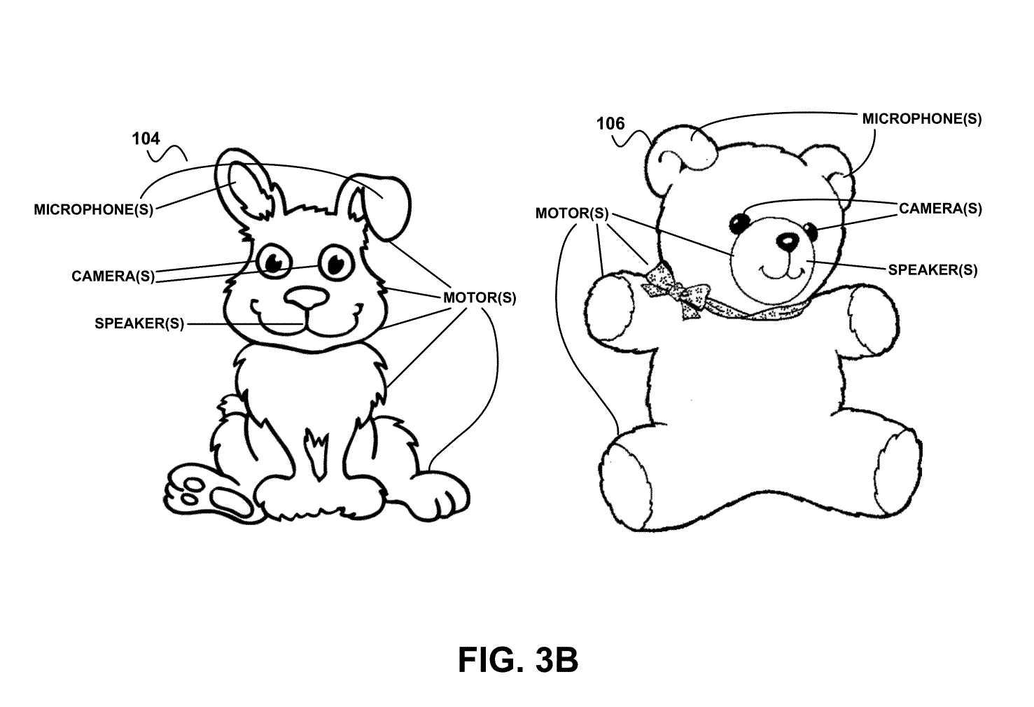

FIG. 3A is a simplified block diagram showing some of the hardware and software components of an example client device 300. By way of example and without limitation, client device 300 may be an anthropomorphic device, such as one of anthropomorphic devices 104 and 106.

As shown in FIG. 3A, client device 300 may include a communication interface 302, a user interface 304, a processor 306, and data storage 308, all of which may be communicatively linked together by a system bus, network, or other connection mechanism 310.

Communication interface 302 functions to allow client device 300 to communicate, using analog or digital modulation, with other devices, access networks, and/or transport networks. Thus, communication interface 302 may facilitate circuit-switched and/or packet-switched communication, such as POTS communication and/or IP or other packetized communication. For instance, communication interface 302 may include a chipset and antenna arranged for wireless communication with a radio access network or an access point. Also, communication interface 302 may take the form of a wireline interface, such as an Ethernet, Token Ring, or USB port. Communication interface 302 may also take the form of a wireless interface, such as a Wifi, BLUETOOTH®, global positioning system (GPS), or wide-area wireless interface (e.g., WiMAX or LTE). However, other forms of physical layer interfaces and other types of standard or proprietary communication protocols may be used over communication interface 302. Furthermore, communication interface 302 may comprise multiple physical communication interfaces (e.g., a Wifi interface, a BLUETOOTH® interface, and a wide-area wireless interface).

User interface 304 may function to allow client device 300 to interact with a human or non-human user, such as to receive input from a user and to provide output to the user. Thus, user interface 304 may include one or more still or video cameras, microphones, and speakers, as well as various types of sensors. However, user interface 304 may also include more traditional input and output components such as a keypad, keyboard, touch-sensitive or presence-sensitive panel, computer mouse, trackball, joystick, display screen (which, for example, may be combined with a touch-sensitive panel), CRT, LCD, LED, a display using DLP technology, printer, light bulb, and/or other similar devices, now known or later developed.

In some embodiments, user interface 304 may include software, circuitry, or another form of logic that can transmit data to and/or receive data from external user input/output devices. Additionally or alternatively, client device 300 may support remote access from another device, via communication interface 302 or via another physical interface (not shown).

In some types of client devices, such as anthropomorphic devices, user interface 304 may include one or more motors, actuators, servos, wheels, and so on to allow the client device to move. Further, an anthropomorphic device may also support various types of sensors, such as ultrasound sensors, touch sensors, color sensors, and so on, that enable the anthropomorphic device to receive information about its environment.

Processor 306 may comprise one or more general purpose processors (e.g., microprocessors) and/or one or more special purpose processors (e.g., DSPs, GPUs, FPUs, network processors, or ASICs). Data storage 308 may include one or more volatile and/or non-volatile storage components, such as magnetic, optical, flash, or organic storage, and may be integrated in whole or in part with processor 306. Data storage 308 may include removable and/or non-removable components.

Generally speaking, processor 306 may be capable of executing program instructions 318 (e.g., compiled or non-compiled program logic and/or machine code) stored in data storage 308 to carry out the various functions described herein. Therefore, data storage 308 may include a non-transitory computer-readable medium, having stored thereon program instructions that, upon execution by client device 300, cause client device 300 to carry out any of the methods, processes, or functions disclosed in this specification and/or the accompanying drawings. The execution of program instructions 318 by processor 306 may result in processor 306 using data 312.

By way of example, program instructions 318 may include an operating system 322 (e.g., an operating system kernel, device driver(s), and/or other modules) and one or more application programs 320 installed on client device 300. Similarly, data 312 may include operating system data 316 and application data 314. Operating system data 316 may be accessible primarily to operating system 322, and application data 314 may be accessible primarily to one or more of application programs 320. Application data 314 may be arranged in a file system that is visible to or hidden from a user of client device 300.

Further, operating system 318 may be a robot operating system (e.g., an operating system designed for specific functions of the robot). Examples of robot operating systems include open source software such as ROS (robot operating system), DROS, or ARCOS (advanced robotics control operating system), and ROSJAVA. Such a robot operating system may include functionality that supports data acquisition via various sensors and movement via various motors.

Application programs 320 may communicate with operating system 312 through one or more application programming interfaces (APIs). These APIs may facilitate, for instance, application programs 320 reading and/or writing application data 314, transmitting or receiving information via communication interface 302, receiving or displaying information on user interface 304, and so on.

E. Anthropomorphic Device Form Factors

FIG. 3B is depicts possible form factors of anthropomorphic devices 104 and 106. As noted previously, anthropomorphic device 104 has a form factor of a rabbit, while anthropomorphic device 106 has a form factor of a teddy bear. Generally speaking, anthropomorphic devices may take on virtually any form. For example, an anthropomorphic device might represent a human, an animal, a fictional creature (e.g., a dragon or an alien life form), or an inanimate object. While anthropomorphic devices 104 and 106 resemble cartoonish dolls or toys, anthropomorphic devices may have other physical appearances. Additionally, an anthropomorphic device may not be a physical device at all. Instead the anthropomorphic “device” may be a hologram or avatar on a computer screen.

There are at least some advantages to an anthropomorphic device taking on a familiar, toy-like, or “cute” form, such as the form factors of anthropomorphic devices 104 and 106. Some users, especially young children, might find these forms to be attractive user interfaces. However, individuals of all ages may find interacting with these anthropomorphic devices to be more natural than interacting with traditional types of user interfaces.

Communication with anthropomorphic devices may be facilitated by various sensors built into and/or attached to the anthropomorphic devices. As noted above, anthropomorphic device 104 may be equipped with one or more microphones, still or video cameras, speakers, and/or motors. In some embodiments, the sensors may be located at or near representations of respective sensing organs. Thus, microphone(s) may be located at or near the ears of anthropomorphic device 104, camera(s) may be located at or near the eyes of anthropomorphic device 104, and speaker(s) may be located at or near the mouth of anthropomorphic device 104.

Additionally, anthropomorphic device 104 may also support non-verbal communication through the use of motors that control the posture, facial expressions, and/or mannerisms of anthropomorphic device 104. For example, these motors might open and close the eyes, straighten or relax the ears, wiggle the nose, move the arms and feet, and/or twitch the tail of anthropomorphic device 104.

Thus, for instance, by using the motor(s) to adjust the angle of its head, anthropomorphic device 104 may appear to gaze at a particular user or object. With one or more cameras being located at or near its eyes, this movement may also provide anthropomorphic device 104 with a better view of the user or object. Further, with one or more microphones located at or near its ears and one or more speakers located at or near its mouth, this movement may also facilitate audio communication with the user or object.

Similar to anthropomorphic device 104, anthropomorphic device 106 may also have sensors located at or near representations of respective sensing organs, and may also use various motors to support non-verbal communication.

Anthropomorphic devices 104 and 106 may be configured to express such non-verbal communication in a human-like fashion, based on social cues or a phase of communication between the anthropomorphic device and a user. For example, anthropomorphic devices 104 and 106 may simulate human-like expressions of interest, curiosity, boredom, and/or surprise.

To express interest, an anthropomorphic device may open its eyes, lift its head, and/or focus its gaze on the user or object of its interest. To express curiosity, an anthropomorphic device may tilt its head, furrow its brow, and/or scratch its head with an arm. To express boredom, an anthropomorphic device may defocus its gaze, direct its gaze in a downward fashion, tap its foot, and/or close its eyes. To express surprise, an anthropomorphic device may make a sudden movement, sit or stand up straight, and/or dilate its pupils. However, an anthropomorphic device may use other non-verbal movements to simulate these or other emotions.

It should be noted that while the anthropomorphic devices described herein may have eyes that can “close,” or may be able to simulate “sleeping,” the anthropomorphic devices may maintain their camera and microphones in an operational state. Thus, the anthropomorphic devices may be able to detect movement and sounds even when appearing to be asleep. Nonetheless, when in such a “sleep mode” an anthropomorphic device may deactivate or limit at least some of its functionality in order to use less power.

### 4. Control of Media Devices

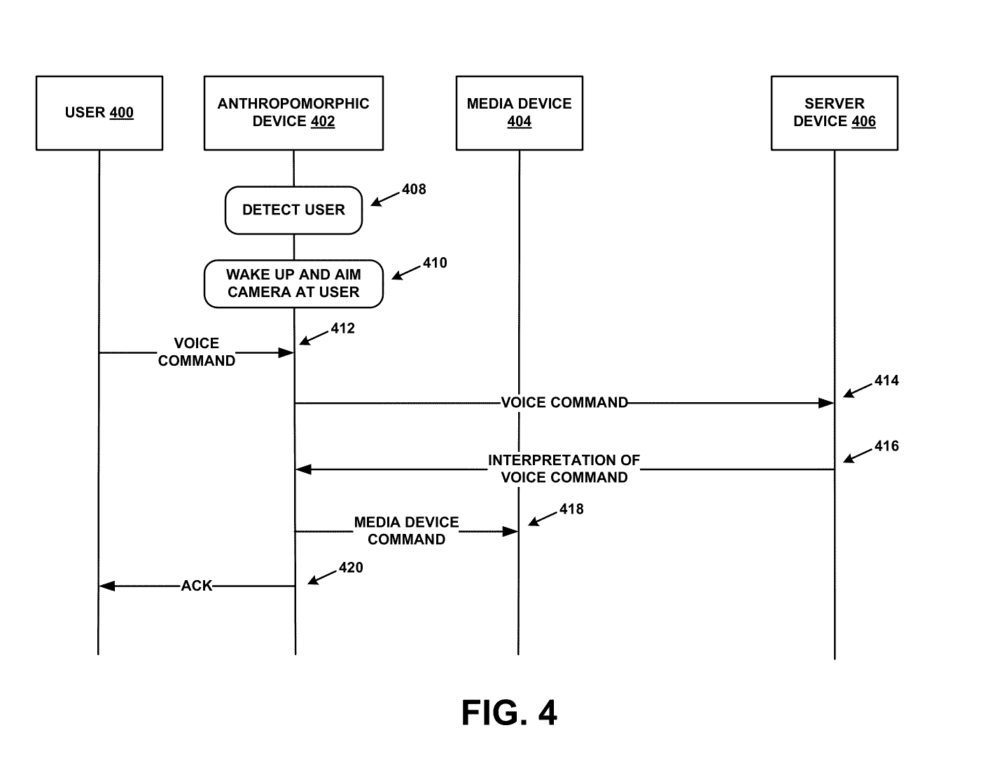

FIG. 4 is a message flow representing communication between an anthropomorphic device and various other devices in order to control a media device. Particularly, anthropomorphic device 402, media device 404, and server device 406 may exchange messages to enable user 400 to verbally control media device 404. Media device 404 may be any type of media playback apparatus or system, such as a television, stereo, or computer. Media device 404 also could be a home automation device or some other type of device.

Server device 406 may be one or more servers or server clusters, such as those discussed in reference to FIGS. 2A and 2B. Anthropomorphic device 402 may communicate with server device 406 to offload at least some of the processing associated with mapping various social cues received from a user to one or more distinct media device commands.

At step 408, anthropomorphic device 402 may detect the presence of user 400. Anthropomorphic device 402 may use some combination of one or more sensors to detect user 400. For example, a camera or an ultrasound sensor of anthropomorphic device 402 may detect motion of user 400, a microphone of anthropomorphic device 402 may detect sound caused by user 400, or a touch sensor of anthropomorphic device 402 may be activated by user 400. Alternatively or additionally, another device may inform anthropomorphic device 402 of the presence of user 400. For instance, a nearby motion or sound sensing device may detect the presence of user 400 and transmit a signal to anthropomorphic device 402 (e.g., over Wifi or BLUETOOTH) in order to notify anthropomorphic device 402 of the user's presence.

In some situations, anthropomorphic device 402 may support a low-power sleep mode, in which anthropomorphic device 402 may deactivate or partially deactivate one or more of its interfaces or functions. Thus, at step 410, anthropomorphic device 402 may “wake up,” and transition from the sleep mode to an active mode. Accordingly, anthropomorphic device 402 may exhibit the social cues of waking up, such as opening its eyes, yawning, and/or stretching. Anthropomorphic device 402 may also greet the detected user, perhaps addressing the user by name and/or asking the user if he or she would like any assistance.

Additionally, anthropomorphic device 402 may aim its camera(s), and perhaps other sensors as well, at user 400. This aiming may involve anthropomorphic device 402 rotating and/or tilting its head in order to appear as if it is looking at user 400. If anthropomorphic device 402 had deactivated or limited any of its functionality while in sleep mode, anthropomorphic device 402 may reactivate or otherwise power this functionality. For instance, if anthropomorphic device 402 had deactivated one or more of its network interfaces while in sleep mode, anthropomorphic device 402 may reactivate these interfaces.

At step 412, anthropomorphic device 402 may receive a voice command from user 400. The voice command may contain one or more words, phrases, and/or sounds. Anthropomorphic device 402 may process the voice command (e.g., performing speech recognition) to interpret and/or assign a meaning to the voice command. Alternatively, and as shown at step 414, anthropomorphic device 402 may transmit a representation of the voice command to server 406. Server 406 may interpret and/or assign a meaning to the voice command, and at step 416 transmit this interpretation back to anthropomorphic device 402.

One possible advantage of offloading this interpretation and/or assignment of a meaning to the voice command to server 406 is that server 406 may have significantly greater processing power and storage than anthropomorphic device 402. Therefore, server device 406 may be able to determine the intended meaning of the voice command with greater accuracy and in a shorter period of time than anthropomorphic device 402.

In response to receiving this interpretation of the voice command, at step 418, anthropomorphic device 402 may transmit a media device command to media device 404. The media device command may instruct media device 404 to change its state. Further, the media device command may be based on, or derived from, the voice command as interpreted.

Thus, for example, if the voice command is “turn on channel 7,” and media device 404 is a television, the media device command may instruct the television to turn on (if it isn't already on) and tune to channel 7. However, voice commands can be less specific. For instance, if the voice command is “weather report,” the media device command may instruct media device 404 to display or play out a recent weather report. If the voice command is “play late-period John Coltrane,” the media device command may instruct media device 404 to play music recorded by John Coltrane between 1965 and 1967.

Regardless of the type of media device and media, at step 420, anthropomorphic device 402 may acknowledge reception and/or acceptance of the voice command. This acknowledgement may take various forms, such as an audio signal (e.g., a spoken word or phrase, a beep, and/or a tone) and/or a visual signal (e.g., anthropomorphic device 402 may nod and/or display a light).

There are various alternative embodiments that can be used to enhance the steps of FIG. 4. For example, For example, at step 410, through one or more of its cameras, anthropomorphic device 402 may capture a video of user 400 while he or she speaks the voice command. Then, from the video, anthropomorphic device 402 may perform further speech recognition by automatically reading the lips to of user 400. This video-based speech recognition can be used in conjunction with the audio-based speech recognition to interpret and/or assign a meaning to the voice command. Alternatively or additionally, at step 414, anthropomorphic device 402 may transmit some or all of the captured video to server device 406. Then, server device 406 may perform the video-based speech recognition (also perhaps in conjunction with the audio-based speech recognition), and at step 416 may transmit an interpretation of the resulting recognized speech.

In some embodiments, anthropomorphic device 402 may be configured to accept voice commands from a limited number of users. For example, if anthropomorphic device 402 controls the media devices in the living room of a house, perhaps anthropomorphic device 402 may only accept voice commands from the residents of the house. Therefore, anthropomorphic device 402 may store, or have access to, a profile for each resident of the house. Such a profile may contain a representative voice sample and/or facial picture of the respective resident.

In order to determine whether user 400 is authorized to issue voice commands to anthropomorphic device 402, anthropomorphic device 402 may use the voice command and/or one or more frames from captured video of user 400 to determine whether this input from user 400 matches one of the profiles. If input from user 400 does match one of the profiles, anthropomorphic device 402 may issue the media device command. However, if input from user 400 does not match one of the profiles, anthropomorphic device 402 may refrain from issuing the media device command.

An additional advantage of being able to recognize the voice and face of user 400 is to further enhance the ability of anthropomorphic device 402 to correctly interpret voice commands in noisy scenarios. For instance, suppose that anthropomorphic device 402 is in a crowded room with several individuals, other than user 400, that are speaking Anthropomorphic device 402 may be able to better filter the voice of user 400 from other voices by using its camera(s) to read the lips of user 400.

In embodiments in which anthropomorphic device 402 includes a microphone array, anthropomorphic device 402 may use acoustic beamforming to filter the voice of user 400 from other voices and/or noises. For example, via the microphone array, anthropomorphic device 402 may determine the time delay between the arrivals of audio signals at the different microphones in the array to determine the direction of an audio source. Further, anthropomorphic device 402 may use the copies of these audio signals from the different microphones to strengthen the signal from the desired audio source (e.g., user 400) and attenuate environmental noise from other parts of the room. Thus, the camera and microphone array may be used in conjunction with one another to focus on the speaker for better audio quality (and perhaps improving speech recognition accuracy as a result), and/or to verify that audio commands received by the microphones were coming from the direction of user 400, and not from somewhere else in the room.

Alternatively or additionally, anthropomorphic device 402 may be able to filter the voice of user 400 by comparing the voice command to one or more samples or representations of the voice of user 400 stored in a profile. Such a profile may also contain custom, user-specific mappings of voice commands to media device commands. For instance, user 400 might define a custom mapping so that when he or she speaks the voice command “weather,” anthropomorphic device 402 instruct media device 404 to display the 5-day weather forecast from a pre-determined weather service provider, with a map of the current local radar. In contrast to this custom mapping, if a different user speaks the command weather, anthropomorphic device 402 (perhaps by default) may instruct media device 404 to display just the current local temperature.

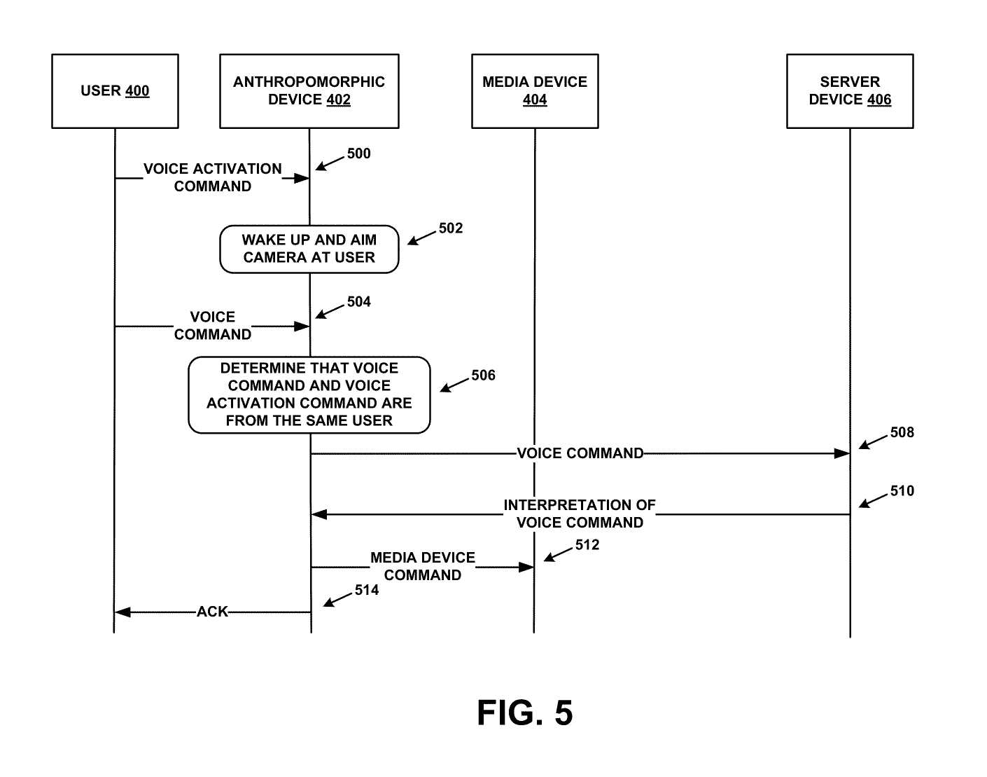

FIG. 5 is another message flow representing communication between user 400, anthropomorphic device 402, media device 404, and server device 406. This message flow allows the activation of anthropomorphic device 402 based on an audio signal, or some combination of an audio signal and a visual signal.

Accordingly, at step 500, anthropomorphic device 402 may receive a voice activation command from user 400. This voice activation command may be any type of vocal signal that serves to activate anthropomorphic device 402. Thus, for example, the voice activation command could be a word, phrase, a sound of a certain pitch, and/or a particular pattern or sequence of sounds. In some embodiments, anthropomorphic device 402 may be given a “name” and the voice activation command may include its name. For instance, if anthropomorphic device 402 is given the name “Larry,” potentially any audio signal including the sound “Larry” could activate anthropomorphic device 402.

By supporting such a voice activation command, a user can rapidly activate anthropomorphic device 402 without anthropomorphic device 402 having to detect the user with a camera or some other type of non-audio sensor. Therefore, to save power, anthropomorphic device 402 may be able to deactivate its camera, and possibly other sensors as well, when not interacting with a user.

At step 502, anthropomorphic device 402 may “wake up,” and transition from the sleep mode to an active mode. In doing so, anthropomorphic device 402 may perform any of the actions discussed in reference to step 410, such as exhibiting social cues of waking up, aiming its one or more sensors (e.g., a camera) at user 400, and/or reactivating or otherwise powering up deactivated functionality.

At step 504, anthropomorphic device 402 may receive a voice command from user 400. The voice command may contain one or more words, phrases, and/or sounds. In some embodiments, the voice command may include a particular keyword or phrase that anthropomorphic device 402 uses to discern voice commands from other sounds. If anthropomorphic device 402 is given a name, it may only respond to voice commands that include its name.

At step 506, possibly in response to receiving the voice command, anthropomorphic device 402 may determine that the voice activation command and the voice command are from the same user. Anthropomorphic device 402 may make this determination based on one or more of (i) analysis of the voice activation command and/or the voice command, (ii) facial recognition of user 400, and (iii) comparison of the voice activation command, the voice command and/or the face of user 400 to one or more profiles of authorized users.

Similar to step 412, after receiving the voice command, anthropomorphic device 402 may process the voice command to interpret and/or assign a meaning to the voice command. Alternatively or additionally, and as shown at step 508, anthropomorphic device 402 may transmit a representation of the voice command to server 406. Server 406 may interpret and/or assign a meaning to the voice command, and at step 510 transmit this interpretation back to anthropomorphic device 402.

At step 512, in response to receiving this interpretation of the voice command, anthropomorphic device 402 may transmit a media device command to media device 404. The media device command may instruct media device 404 to change its state. Additionally, at step 514, anthropomorphic device 402 may acknowledge reception and/or acceptance of the voice command.

Although FIGS. 4 and 5 show just one media device, media device 404, anthropomorphic device 402 may be able to control multiple media devices. Further, these media devices may be collocated with anthropomorphic device 402, or may be in a different room, building, or geographic region than anthropomorphic device 402.

Additionally, part of processing the voice command may involve anthropomorphic device 402 determining which media device(s) to send the corresponding media device command based on the context of the voice command. For instance, anthropomorphic device 402 may be capable of controlling a television and a thermostat. Therefore, if user 400 instructs anthropomorphic device 402 to play a television show, anthropomorphic device 402 may determine that the television is the appropriate device for playing the television show. Similarly, if user 400 instructs anthropomorphic device 402 to change a temperature, anthropomorphic device 402 may determine that the thermostat is the appropriate device for carrying out this command.

### 5. Example Operation

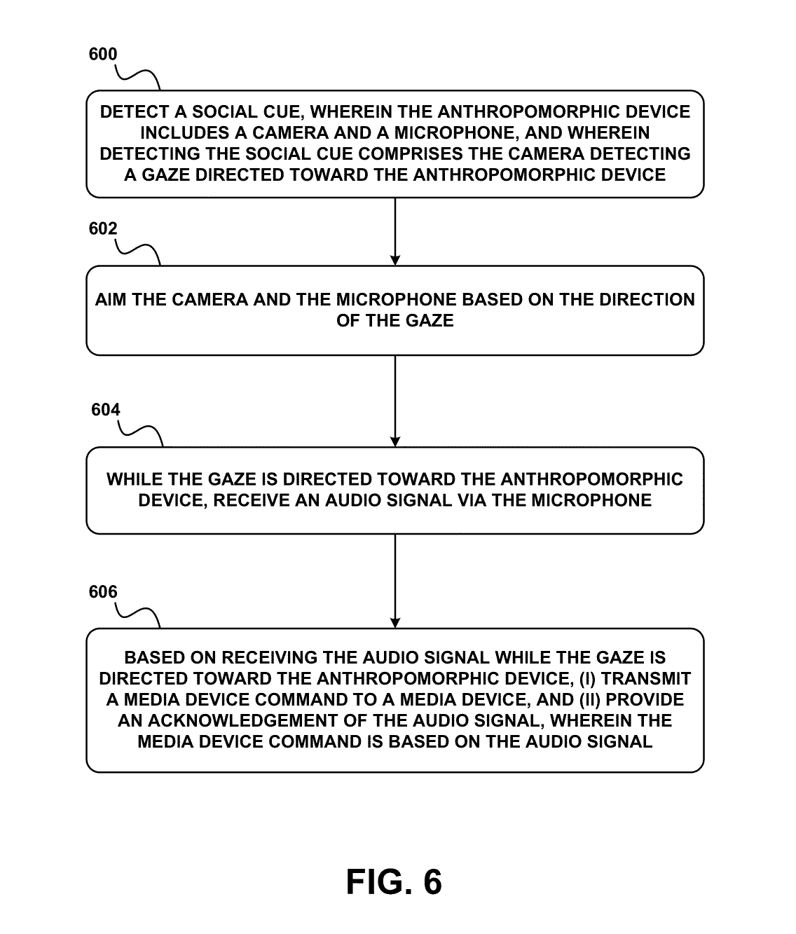

FIG. 6 is a flow chart of a method that could be performed by an anthropomorphic device to carry out at least some of the functions described in reference to FIGS. 4 and 5. The anthropomorphic device may be in the form factor of a doll or toy, and therefore may include a head. The anthropomorphic device may include a camera and a microphone, perhaps attached to the head.

The anthropomorphic device may be capable of controlling one or more media devices. Thus, upon receiving a voice command, the anthropomorphic device may issue a corresponding media device command to a media device. The media device may be, for example, a television, computer, stereo component, or home automation component.

At step 600, an anthropomorphic device may detect a social cue. Detecting the social cue may involve the camera detecting a gaze of a user directed toward the anthropomorphic device. Detecting the social cue may further involve identifying the user. perhaps by performing facial recognition on the user. Based on the identity of the user, the anthropomorphic device may determine that the user has permission to use the anthropomorphic device. Alternatively or additionally, anthropomorphic device may have access to a profile of the user. The profile may contain one or more preferences of the user that map audio signals to media device commands, and transmitting the media device command to the media device may be based on looking up the audio signal in the mapping to find the media device command.

At step 602, possibly in response to detecting the social cue, the anthropomorphic device may aim the camera and the microphone based on the direction of the gaze. Aiming the camera and the microphone based on the direction of the gaze may involve turning the head of the anthropomorphic device, or otherwise aiming the camera and the microphone at a source of the gaze (e.g., at the user).

Additionally, the anthropomorphic device may support a sleep mode and an active mode, and the anthropomorphic device may use less power when in the sleep mode than when in the active mode. Possibly in response to detecting the social cue, the anthropomorphic device may transition from the sleep mode to the active mode.

At step 604, while the gaze is directed toward the anthropomorphic device, the anthropomorphic device may receive an audio signal via the microphone. Receiving the audio signal may involve the anthropomorphic device filtering the audio signal from background noise received with the audio signal. In some embodiments, the anthropomorphic device may also receive, via the camera, a non-audio signal. This non-audio signal, may be used in combination with the audio signal to perform the filtering.

At step 606, based on receiving the audio signal while the gaze is directed toward the anthropomorphic device, the anthropomorphic device may (i) transmit a media device command to a media device, and (ii) provide an acknowledgement of the audio signal, wherein the media device command is based on the audio signal.

The audio signal may be a voice command that directs the anthropomorphic device to change a state of the media device, and the media device command may instruct the media device to change the state. In some embodiments, the media device may be a home entertainment system or home automation system component. If the anthropomorphic device received a non-audio signal at step 604, transmitting the media device command to the media device may also be based on receiving the non-audio signal.

The anthropomorphic device may also include a speaker, and providing the acknowledgment may involve the anthropomorphic device producing a sound via the speaker. Alternatively or additionally, providing the acknowledgment may involve the anthropomorphic device producing a visible acknowledgement.

As noted above, the anthropomorphic device may support a sleep mode and an active mode. After receiving the audio signal, the anthropomorphic device may detect inactivity for a given period of time. Detecting inactivity may involve the anthropomorphic device receiving no input from a user during the given period of time and/or determining that the user who issued the voice command is no longer in the vicinity of the anthropomorphic device. The given period of time may be some number of seconds (e.g., 10 seconds, 30 seconds, 60seconds), to several minutes or more (e.g., 2 minutes, 5 minutes, 30 minutes, 1 hour, etc.). In response to detecting the inactivity for the given period of time, the anthropomorphic device may transition from the active mode to the sleep mode.

A given location, such as a residence or business, may support multiple anthropomorphic devices, each anthropomorphic device controlling one or more sets of media devices. For example, in a residence, one anthropomorphic device may control media devices in the living room, while another anthropomorphic device may control the media devices in the bedroom. Alternatively or additionally, multiple anthropomorphic devices may control the same media devices.

Accordingly, a second anthropomorphic device may detect a second social cue. Similar to the first anthropomorphic device, the second anthropomorphic device may include a second camera and a second microphone. Detecting the second social cue may involve the second camera detecting a second gaze directed toward the second anthropomorphic device.

The second anthropomorphic device may then aim the second camera and the second microphone based on the direction of the second gaze. While the second gaze is directed toward the second anthropomorphic device, the second anthropomorphic device may receive, via the second microphone, a second audio signal. Based on receiving the second audio signal while the second gaze is directed toward the second anthropomorphic device, the second anthropomorphic device may (i) transmit a second media device command to the media device, and (ii) provide a second acknowledgement of the second audio signal, wherein the second media device command is based on the second audio signal.

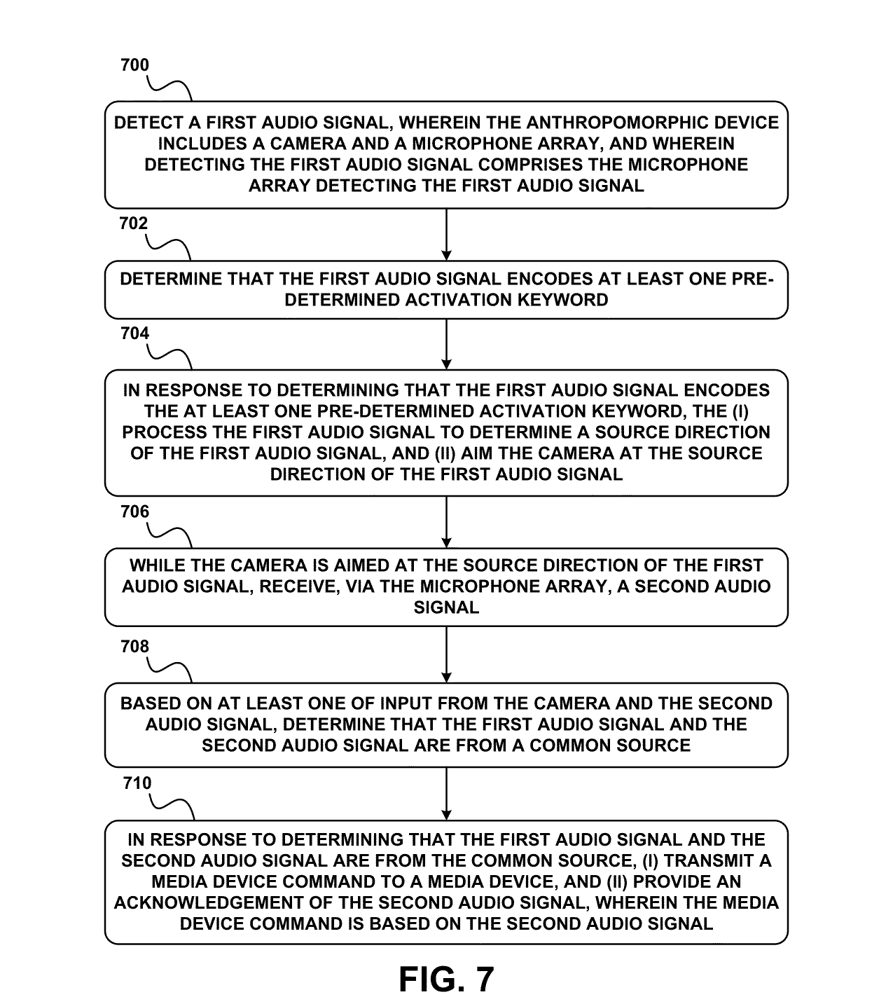

FIG. 7 is a flow chart of another method that could be performed by an anthropomorphic device to carry out at least some of the functions described in reference to FIGS. 4 and 5. Again, the anthropomorphic device may be in the form factor of a doll or toy and may include a camera and a microphone array.

At step 700, the anthropomorphic device may detect a first audio signal via the microphone array. At step 702, the anthropomorphic device may determine that the first audio signal encodes at least one pre-determined activation keyword.

At step 704, in response to determining that the first audio signal encodes the at least one pre-determined activation keyword, the anthropomorphic device may (i) process the first audio signal to determine a source direction of the first audio signal, and (ii) aim the camera at the source direction of the first audio signal. Determining the source direction of the first audio signal may involve, for instance, (i) receiving the audio signal at different respective arrival times at two or more microphones of the array, and (ii) estimating the source direction of the first audio signal from the differences between these different arrival times. Aiming the camera may involve the anthropomorphic device turning its head (if it has a head) toward the source direction of the audio signal.

At step 706, while the camera is aimed at the source direction of the first audio signal, the anthropomorphic device may receive a second audio signal via the microphone array. At step 708, based on at least one of input from the camera and the second audio signal, the anthropomorphic device may determine that the first audio signal and the second audio signal are from a common source. At step 710, in response to determining that the first audio signal and the second audio signal are from the common source, the anthropomorphic device may (i) transmit a media device command to a media device, and (ii) provide an acknowledgement of the second audio signal, wherein the media device command is based on the second audio signal.

### 6. Conclusion

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium such as a storage device including a disk or hard drive or other storage media.

The computer-readable medium may also include non-transitory computer-readable media such as computer-readable media that stores data for short periods of time like register memory, processor cache, and/or random access memory (RAM). The computer-readable media may also include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media may also be any other volatile or non-volatile storage systems. A computer-readable medium may be considered a computer-readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method comprising:
an anthropomorphic device detecting a social cue, wherein the anthropomorphic device includes a camera and a microphone, and wherein detecting the social cue comprises the camera detecting a gaze directed toward the anthropomorphic device;
the anthropomorphic device aiming the camera and the microphone based on the direction of the gaze;
while the gaze is directed toward the anthropomorphic device, the anthropomorphic device receiving an audio signal via the microphone; and
based on receiving the audio signal while the gaze is directed toward the anthropomorphic device, the anthropomorphic device (i) transmitting a media device command to a media playback device, wherein the media playback device is separate from the anthropomorphic device, and (ii) providing an acknowledgement of the audio signal, wherein the media device command is based on the audio signal and instructs the media playback device to play out selected content.

2. The method of claim 1, wherein the anthropomorphic device comprises a head, and wherein the camera and the microphone are attached to the head.

3. The method of claim 1, wherein the audio signal is a voice command that directs the anthropomorphic device to change a state of the media playback device, and wherein the media device command instructs the media playback device to change the state.

4. The method of claim 1, wherein detecting the social cue further comprises identifying a user associated with the gaze directed toward the anthropomorphic device.

5. The method of claim 4, wherein identifying the user comprises:
performing facial recognition on the user to determine an identity of the user; and
based on the identity of the user, determining that the user has permission to use the anthropomorphic device.

6. The method of claim 5, wherein the anthropomorphic device has access to a profile of the user, wherein the profile contains one or more preferences of the user that map audio signals to media device commands, and wherein transmitting the media device command to the media playback device is based on looking up the audio signal in the mapping to find the media device command.

7. The method of claim 1, further comprising:
the anthropomorphic device also receiving, via the camera, a non-audio signal, wherein
transmitting the media device command to the media playback device is also based on receiving the non-audio signal.

8. The method of claim 1, wherein receiving the audio signal comprises filtering the audio signal from background noise received with the audio signal.

9. The method of claim 1, wherein the anthropomorphic device also includes a speaker,
and wherein providing the acknowledgment comprises producing a sound via the speaker.

10. The method of claim 1, further comprising:
in response to detecting the social cue, the anthropomorphic device transitioning from a sleep mode to an active mode, wherein the anthropomorphic device uses less power when in the sleep mode than when in the active mode.

11. The method of claim 10, further comprising:
after receiving the audio signal, the anthropomorphic device detecting inactivity for a given period of time; and
in response to detecting inactivity for the given period of time, the anthropomorphic device transitioning from the active mode to the sleep mode.

12. The method of claim 1, wherein aiming the camera and the microphone based on the direction of the gaze comprises aiming the camera and the microphone at a source of the gaze.

13. The method of claim 1, further comprising:
a second anthropomorphic device detecting a second social cue, wherein the second anthropomorphic device includes a second camera and a second microphone, and wherein detecting the second social cue comprises the second camera detecting a second gaze directed toward the second anthropomorphic device;
the second anthropomorphic device aiming the second camera and the second microphone based on the direction of the second gaze;
while the second gaze is directed toward the second anthropomorphic device, the second
anthropomorphic device receiving, via the second microphone, a second audio signal; and
based on receiving the second audio signal while the second gaze is directed toward the second anthropomorphic device, the second anthropomorphic device (i) transmitting a second media device command to the media playback device, and (ii) providing a second acknowledgement of the second audio signal, wherein the second media device command is based on the second audio signal.

14. An article of manufacture including a non-transitory computer-readable medium, having stored thereon program instructions that, upon execution by an anthropomorphic computing device, cause the anthropomorphic computing device to perform operations comprising:
detecting a social cue at the anthropomorphic computing device, wherein the anthropomorphic computing device includes a camera and a microphone, and wherein detecting the social cue comprises the camera detecting a gaze directed toward the anthropomorphic computing device;
aiming the camera and the microphone based on the direction of the gaze;
while the gaze is directed toward the anthropomorphic computing device, receiving an audio signal via the microphone; and
based on receiving the audio signal while the gaze is directed toward the anthropomorphic computing device, (i) transmitting a media device command to a media playback device, wherein the media playback device is separate from the anthropomorphic device, and (ii) providing an acknowledgement of the audio signal, wherein the media device command is based on the audio signal and instructs the media playback device to play out selected content.

15. The article of manufacture of claim 14, wherein the audio signal is a voice command that directs the anthropomorphic computing device to change a state of the media playback device, and wherein the media device command instructs the media playback device to change the state.

16. The article of manufacture of claim 14, wherein detecting the social cue further comprises identifying a user associated with the gaze directed toward the anthropomorphic computing device.

17. The article of manufacture of claim 16, wherein identifying the user comprises:
performing facial recognition on the user to determine an identity of the user; and
based on the identity of the user, determining that the user has permission to use the anthropomorphic computing device.

18. The article of manufacture of claim 17, wherein the anthropomorphic computing device has access to a profile of the user, wherein the profile contains one or more preferences of the user that map audio signals to media device commands, and wherein transmitting the media device command to the media playback device is based on looking up the audio signal in the mapping to find the media device command.

19. The article of manufacture of claim 14, wherein the operations further comprise:
in response to detecting the social cue, transitioning from a sleep mode to an active mode, wherein the anthropomorphic computing device uses less power when in the sleep mode than when in the active mode.

20. A method comprising:
an anthropomorphic device detecting a first audio signal, wherein the anthropomorphic device includes a camera and a microphone array, and wherein detecting the first audio signal comprises the microphone array detecting the first audio signal;
the anthropomorphic device determining that the first audio signal encodes at least one pre-determined activation keyword;
in response to determining that the first audio signal encodes the at least one pre-determined activation keyword, the anthropomorphic device (i) processing the first audio signal to determine a source direction of the first audio signal, and (ii) aiming the camera at the source direction of the first audio signal;
while the camera is aimed at the source direction of the first audio signal, the anthropomorphic device receiving a second audio signal via the microphone array;
based on at least one of input from the camera and the second audio signal, the anthropomorphic device determining that the first audio signal and the second audio signal are from a common source; and
in response to determining that the first audio signal and the second audio signal are from the common source, the anthropomorphic device (i) transmitting a media device command to a media playback device, wherein the media playback device is separate from the anthropomorphic device, and (ii) providing an acknowledgement of the second audio signal, wherein the media device command is based on the second audio signal and instructs the media playback device to play out selected content.
